(19) United States
(12) Patent Application Publication
(10) Pub. No.: US 2024/0360250 A1
(43) Pub. Date: Oct. 31, 2024

(54) NOVEL HYDROXYALKYL METHYLCELLULOSE AND ITS USE

(71) Applicant: Nutrition & Biosciences USA 1, LLC, Rochester, NY (US)

(72) Inventors: MATTHIAS KNARR, BOMLITZ (DE); OLIVER PETERMANN, BOMLITZ (DE)

(21) Appl. No.: 18/686,630

(22) PCT Filed: Aug. 18, 2022
(86) PCT No.: PCT/EP2022/073075

§ 371 Date: Feb. 26, 2024

(30) Foreign Application Priority Data
Aug. 26, 2021 (EP) 21193170.4

(51) Int. Cl. C08B 11/193; A23L 29/262; C08B 11/08

(52) U.S. Cl. CPC C08B 11/193; A23L 29/262; C08B 11/08

(57) ABSTRACT

A hydroxyalkyl methylcellulose wherein the substitution pattern of the hydroxyalkyl groups of the anhydroglucose units of the hydroxyalkyl methylcellulose is such that the s6(hydroxyalkyl) is 0.01-0.1, wherein s6 is the molar fraction of the anhydroglucose units of the hydroxyalkyl methylcellulose wherein the hydroxy groups in the 6 position of the anhydroglucose unit are substituted by hydroxyalkyl, and wherein the substitution pattern of the methoxyl groups of the anhydroglucose units of the hydroxyalkyl methylcellulose is such that the s23/s26(methyl) ratio is from 0.36 to 0.60, wherein s23 is the molar fraction of anhydroglucose units wherein only the hydroxy groups in the 2 and 3 positions of the anhydroglucose unit are substituted with methyl, and wherein s26 is the molar fraction of anhydroglucose units wherein only the hydroxy groups in the 2 and 6 positions of the anhydroglucose units are substituted with methyl.

### FIELD

The present invention relates to novel hydroxyalkyl methylcelluloses and their use for ceramic extrusion, in food compositions and as excipients in oral dosage forms.

### BACKGROUND

Hydroxyalkyl methylcelluloses, such as hydroxypropyl methylcelluloses, are widely used and accepted in pharmaceutical applications, for example for the production of hard capsules, tablet coatings or as a matrix polymer in tablets, bakery fillings, fried foods, meat and meat analogs as well as organic binders for inorganic materials, particularly ceramic-forming materials.

Hydroxyalkyl methylcelluloses, such as hydroxypropyl methylcelluloses, are known to exhibit reverse thermal gelation in water, in other words, aqueous hydroxypropyl methylcellulose materials are soluble at cooler temperatures and gel at warmer temperatures. The reverse thermal gelation in water is discussed in detail in the Article Thermal Gelation Properties of Methyl and Hydroxypropyl Methylcellulose by N. Sarkar, Journal of Applied Polymer Science, Vol. 24, 1073-1087 (1979). Described specifically, when an aqueous solution of hydroxypropyl methylcellulose is heated, de-hydration of the hydrophobic methoxyl groups localized in the molecule occurs and it turns into a hydrous gel. When the resulting gel is cooled, on the other hand, the hydrophobic methoxyl groups are re-hydrated, whereby the gel returns to the original aqueous solution. Hydroxyalkyl methylcelluloses are known to have a low storage modulus, compared to methyl cellulose. Hydroxyalkyl methylcelluloses which exhibit a low storage modulus do not form strong gels. High concentrations are needed to form even weak gels (Haque, A; Richardson, R. K.; Morris, E. R., Gidley, M. J and Caswell, D. C in Carbohydrate Polymers 22 (1993) p. 175; and Haque, A and Morris, E. R. in Carbohydrate Polymers 22 (1993) p. 161). For example, at the same concentration of 2 wt.-%, at elevated temperatures the maximum storage modulus of a METHOCEL™ K4M HPMC is typically less than about 100 Pa, whereas that of a METHOCEL™ A4M methylcellulose is typically above about 1000 Pa.

### SUMMARY

It has surprisingly been found possible to prepare hydroxyalkyl methylcelluloses that, unlike the hydroxyalkyl methylcelluloses disclosed in the literature summarized above, exhibit enhanced gel strength at elevated temperatures.

Accordingly, the present invention relates to a hydroxyalkyl methylcellulose wherein the substitution pattern of the hydroxyalkyl groups of the anhydroglucose units of the hydroxyalkyl methylcellulose is such that the s6(hydroxyalkyl) is 0.01-0.1, wherein s6 is the molar fraction of the anhydroglucose units of the hydroxyalkyl methylcellulose wherein the hydroxy groups in the 6 position of the anhydroglucose unit are substituted by hydroxyalkyl, and wherein the substitution pattern of the methoxyl groups of the anhydroglucose units of the hydroxyalkyl methylcellulose is such that the s23/s26(methyl) ratio is from 0.36 to 0.60, wherein s23 is the molar fraction of anhydroglucose units wherein only the hydroxy groups in the 2 and 3 positions of the anhydroglucose unit are substituted with methyl, and wherein s26 is the molar fraction of anhydroglucose units wherein only the hydroxy groups in the 2 and 6 positions of the anhydroglucose units are substituted with methyl.

In a further aspect, the invention relates to a composition for the manufacture of an extrusion-molded ceramic body comprising an inorganic material that sets as a result of baking or sintering, the hydroxyalkyl methylcellulose described herein and water.

In a still further aspect, the invention relates to a solid food composition designed to be heat-treated comprising the hydroxyalkyl methylcellulose described herein.

### DETAILED DESCRIPTION

In the hydroxyalkyl methylcelluoses of the present invention the ether substituents are methyl groups, hydroxyalkyl groups, and optionally alkyl groups which are different from methyl. The hydroxyalkyl groups can be the same or different from each other. Preferably the hydroxyalkyl methylcellulose comprises one or two kinds of hydroxyalkyl groups, more preferably one or more kinds of hydroxy-C₁₋₃-alkyl groups, such as hydroxypropyl and/or hydroxyethyl. Useful optional alkyl groups are, e.g., ethyl or propyl, ethyl being preferred. Preferred hydroxyalkyl methyl celluloses are hydroxy-C₁₋₃-alkyl methyl celluloses, such as hydroxypropyl methylcelluloses or hydroxyethyl methylcelluloses.

An essential feature of the novel hydroxyalkyl methylcelluloses that is believed to be critical for their ability to form a gel at elevated temperatures is their unique distribution of hydroxyalkyl groups on the anhydroglucose units such that the s6(hydroxyalkyl) is from 0.01 to 0.1, wherein s6 is the molar fraction of the anhydroglucose units of the hydroxyalkyl methylcellulose wherein the hydroxy groups in the 6 position of the anhydroglucose unit are substituted by hydroxyalkyl. In a preferred embodiment, the s6(hydroxyalkyl) of the present hydroxyalkyl methylcelluloses is from 0.04 to 0.06. In some embodiments, this s6(hydroxyalkyl) is higher than 0.015, such as higher than 0.020, such as higher than 0.025, such as higher than 0.030, such as higher than 0.035, such as higher than 0.040. In some embodiments, this s6(hydroxyalkyl) is lower than 0.095, such as lower than 0.090, such as lower than 0.085, such as lower than 0.080, such as lower than 0.075, such as lower than 0.070, such as lower than 0.065, such as lower than 0.060.

Another essential feature of the novel hydroxyalkyl methylcelluloses that is also believed to be critical for their ability to form a gel at elevated temperatures is their unique distribution of methyl groups on the anhydroglucose units such that s23/s26 is from 0.36 to 0.60, preferably from 0.40 to 0.48. In some embodiments, this s23/s26(methyl) ratio is higher than 0.37, such as higher than 0.38, such as higher than 0.39, such as higher than 0.40. In some embodiments, this s23/s26(methyl) ratio is lower than 0.59, such as lower than 0.58, such as lower than 0.57, such as lower than 0.56, such as lower than 0.55, such as lower than 0.54, such as lower than 0.53, such as lower than 0.52, such as lower than 0.51, such as lower than 0.50, such as lower than 0.49, such as lower than 0.48, such as lower than 0.47, such as lower than 0.46.

In the ratio s23/s26, s23 is the molar fraction of anhydroglucose units wherein only the two hydroxy groups in the 2- and 3-positions of the anhydroglucose unit are substituted with methyl groups and s26 is the molar fraction of anhydroglucose units wherein only the two hydroxy groups in the 2- and 6-positions of the anhydroglucose unit are substituted with methyl groups. For determining the s23, the term “the molar fraction of anhydroglucose units wherein only the two hydroxy groups in the 2- and 3-positions of the anhydroglucose unit are substituted with methyl groups” means that the 6-positions are not substituted with methyl; for example, they can be unsubstituted hydroxy groups or they can be substituted with hydroxyalkyl groups, methylated hydroxyalkyl groups, alkyl groups different from methyl or alkylated hydroxyalkyl groups. For determining the s26, the term “the molar fraction of anhydroglucose units wherein only the two hydroxy groups in the 2- and 6-positions of the anhydroglucose unit are substituted with methyl groups” means that the 3-positions are not substituted with methyl; for example, they can be unsubstituted hydroxy groups or they can be substituted with hydroxyalkyl groups, methylated hydroxyalkyl groups, alkyl groups different from methyl or alkylated hydroxyalkyl groups.

Formulas I and II below illustrate the numbering of the hydroxy groups in anhydroglucose units. Formulas I and II are only used for illustrative purposes and does not represent the hydroxyalkyl methylcelluloses of the invention.

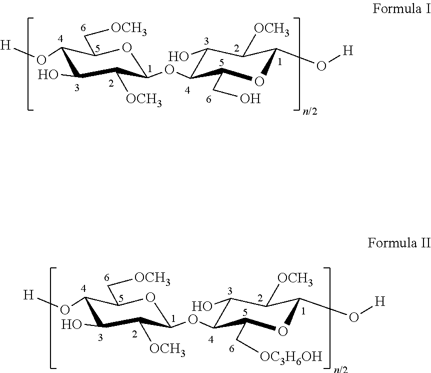

The hydroxyalkyl methylcellulose preferably has a DS(methyl) of from 1.0 to 2.0, more preferably from 1.2 to 1.8. The degree of the methyl substitution, DS(methyl), of a cellulose ether is the average number of OH groups substituted with methyl groups per anhydroglucose unit.

The hydroxyalkyl methylcellulose has an MS(hydroxyalkyl) of 0.05 to 0.5, preferably 0.1 to 0.3. The degree of the hydroxyalkyl substitution is described by the MS (molar substitution). The MS(hydroxyalkyl) is the average number of hydroxyalkyl groups which are bound by an ether bond per mole of anhydroglucose unit. During the hydroxyalkylation, multiple substitutions can result in side chains.

The determination of the % methoxyl and % hydroxypropoxyl in hydroxypropyl methylcellulose is carried out according to the United States Pharmacopeia (USP 32).

The values obtained are % methoxyl and % hydroxypropoxyl. These are subsequently converted into degree of substitution (DS) for methyl substituents and molar substitution (MS) for hydroxypropyl substituents. Residual amounts of salt have been taken into account in the conversion. The DS(methyl) and MS(hydroxyethyl) in hydroxyethyl methylcellulose is effected by Zeisel cleavage with hydrogen iodide followed by gas chromatography. (G. Bartelmus and R. Ketterer, Z. Anal. Chem. 286 (1977) 161-190).

In one embodiment of the present invention, the viscosity of the hydroxyalkyl methylcellulose is from 150 mP·as to 100,000 mP·as determined as a 2% by weight aqueous solution at 20° C. in a Anton Paar Physica MCR 501 rheometer with a cup & bob geometry (CC-27) at 20° C. and at a shear rate of 2.51 s⁻¹. The hydroxyalkyl methylcelluloses having such viscosities are useful for a variety of applications, for example as food ingredients, for ceramic extrusion and as excipients in oral dosage forms.

It has surprisingly been found that the preferred embodiments of the hydroxyalkyl methylcelluloses of the present invention which have a viscosity of more than 150 mPa·s, measured as a 2 wt. % aqueous solution at 20° C. as defined above, do not precipitate at elevated temperatures as a 2 wt. % unlike conventional hydroxyalkyl methylcellulose grades. In contrast, the present hydroxyalkyl methylcelluloses have been found to exhibit a gelation temperature in the range of 55-85° C. The gelation temperature is the temperature at which G/G″=1, G′ being the storage modulus and G″ being the loss modulus of a 2 wt.-% aqueous solution of the cellulose ether. FIG. 1 illustrates the gelation temperatures of hydroxyalkyl methylcelluloses of the present invention. To characterize the temperature dependent properties of the gelation of a 2 weight percent aqueous solution of the cellulose ether, an Anton Paar Physica MCR 501 rheometer (Ostfildern, Germany) with a Cup & Bob set-up (CC-27) and a peltier temperature control system was used in oscillation shear flow. Details of the measurements are described in the Example section. It has surprisingly been found that gelation takes place within a narrow temperature interval such as within a 10° C. interval, expressed as a steep increase of the storage modulus G′ of at least 5 times, or even at least 10 times, the storage modulus at the cross-over of G′=G″ within a temperature interval of 10° C. Such a steep increase of the storage modulus G′ is advantageous in applications where a wide temperature window before gelation takes place facilitates stable processing, e.g. when the hydroxyalkyl methylcellulose is used as an ingredient in ceramic extrusion or in solid food products designed for heat treatment.

It has also surprisingly been found that hydroxyalkyl methylcelluloses of the present invention which have a viscosity of more than 150 mPa·s, determined as a 2% by weight aqueous solution at 20° C. and a shear rate of 2.51 s⁻¹ as defined above have a surprisingly high gel strength. When an aqueous solution of a hydroxyalkyl methylcellulose is characterized by G′/G″≥1, i.e. when it forms a gel, the gel strength is measured as the storage modulus G′. Hydroxyalkyl methylcelluloses of the present invention which have a viscosity of more than 150 mPa·s, determined as a 2% by weight aqueous solution at 20° C. and a shear rate of 2.51 s⁻¹, generally have a storage modulus G′ in the range of 10-10000 Pa, such as in the range of 12-9500 Pa, such as in the range of 14-9000 Pa, such as in the range of 16-8500 Pa, such as in the range of 18-8000 Pa, such as in the range of 20-7500 Pa, such as in the range of 23-7000 Pa, such as in the range of 25-7000 Pa, such as in the range of 10-5000 Pa, such as in the range of 25-5000 Pa, such as in the range of 30-5000 Pa, such as in the range of 40-5000 Pa, such as in the range of 50-5000 Pa, such as in the range of 60-5000 Pa, such as in the range of 70-5000 Pa, such as in the range of 80-5000 Pa, such as in the range of from 90 Pa to 5000 Pa.

The storage modulus G′, the loss modulus G″ and the gelation temperature at which G′/G″=1, each of a 2 weight percent aqueous solution of the cellulose ether are measured in a temperature sweep experiment using an Anton Paar Physica MCR 501 with a peltier temperature control system in oscillation shear flow. A cup & bob geometry (CC-27) is used. The measurements are performed at a constant frequency of 2 Hz. and a constant strain (deformation amplitude) of 0.5% from 20° C. to 85° C. These measurements are conducted with a heating rate of 1° C./min with a data collection rate of 4 points/min. The storage modulus G′, which is obtained from the oscillation measurements, represents the elastic properties of the solution. The loss modulus G″, which is obtained from the oscillation measurements, represents the viscous properties of the solution. During the gelation process of the sample, G′ exceeds G″. The cross-over of G′ and G″ represents the gelation temperature.

Methods of making the novel hydroxyalkyl methylcelluloses of the present invention are described in detail in the Examples. Some aspects of the process for making the novel hydroxyalkyl methylcelluloses are described in more general terms below.

Generally speaking, cellulose pulp or, as the reaction of cellulose pulp to the hydroxyalkyl methyl cellulose proceeds, to partially reacted cellulose pulp, is alkalized in two or more stages, preferably in two or three stages, in one or more reactors with an aqueous alkaline solution of an alkali metal hydroxide, more preferably sodium hydroxide. The aqueous alkaline solution preferably has an alkali metal hydroxide content of from 30 to 70 percent, more preferably from 35 to 60 percent, most preferably from 48 to 52 percent, based on the total weight of the aqueous alkaline solution.

In one embodiment, an organic solvent such as dimethyl ether is added to the reactor as a diluent and a coolant. Likewise, the headspace of the reactor is optionally purged with an inert gas (such as nitrogen) to control oxygen-catalyzed depolymerization of the cellulose ether product.

Typically from 1.2 to 5.0 molar equivalents of alkali metal hydroxide per mole of anhydroglucose units in the cellulose are added in the first stage. Uniform swelling and distribution in the pulp is optionally controlled by mixing and agitation. In the first stage the rate of addition of the alkali metal hydroxide agent is not very critical. It can be added in several portions, e.g., in 2 to 4 portions, or continuously. The temperature at the first stage of contacting the alkali metal hydroxide with the cellulose pulp is typically in the range of 25-65° C., preferably in the range of 40-50° C. The first stage of alkalization typically lasts from 15 to 60 minutes.

A methylating agent, such as methyl chloride or dimethyl sulfate is also added to the cellulose pulp, typically after the addition of the alkali metal hydroxide. The total amount of the methylating agent is generally from 3 to 5.3 mols per mole of anhydroglucose units. The methylating agent can be added to the cellulose or, as the reaction of cellulose pulp to the hydroxyalkyl methyl cellulose proceeds, to partially reacted cellulose pulp, in a single stage or in two stages.

If the methylating agent is added in a single stage, it is generally added in an amount of from 3.4 to 5.3 moles of methylating agent per mole of anhydroglucose units, but in any event it is added in at least an equimolar amount, compared to the added total molar amount of alkali metal hydroxide, before heating the reaction mixture.

If the methylating agent is added in two stages, in the first stage it is generally added in an amount of from 1.6 to 2.0 moles of methylating agent per mole of anhydroglucose units before heating the reaction mixture, but in any event it is added in at least an equimolar amount, compared to the molar amount of alkali metal hydroxide added in the first stage of alkali metal hydroxide addition.

The methylating agent of the single stage or of the first stage may be pre-mixed with the suspending agent. In this case the mixture of suspending agent and methylating agent preferably comprises from 20 to 50 weight percent, more preferably from 30 to 50 weight percent, of the suspending agent, based on the total weight of methylating agent and suspending agent. Once the cellulose has been contacted with the alkali metal hydroxide and methylating agent, the reaction temperature is typically increased over a time period of 30 to 45 minutes to a temperature of about 70-85° C., preferably about 75-80° C., and reacted at this temperature for 80-100 minutes.

If the methylating agent is added in two stages, the second stage of methylating agent is generally added to the reaction mixture after having heated the reaction mixture to a temperature of about 70-85° C. for 10 to 30 minutes. The methylating agent of second stage is generally added in an amount of from 1.2 to 2.0 moles per mole of anhydroglucose units, but in any event it is added in at least an equimolar amount, compared to the molar amount of alkali metal hydroxide present in the reaction mixture. Accordingly, the methylating agent of the second stage, if any, is added to the reaction mixture before or during the second and optionally third stage of alkali metal hydroxide addition in such a manner that the alkali metal hydroxide is not contacted in excess amounts with the cellulose pulp. The methylating agent of the second stage is preferably added at a rate of from 0.25 to 0.5 molar equivalents of methylating agent per mole of anhydroglucose units per minute. If the methylating agent is added in two stages, the molar ratio between the alkali metal hydroxide and methylating agent of the first stage and the alkali metal hydroxide and methylating agent of the second stage is generally from 0.5:1 to 2:1.

If the alkali metal hydroxide is added in two stages, typically from 1.0 to 2.9 molar equivalents of alkali metal hydroxide per mole of anhydroglucose units are added in the second stage, after the addition of the methylating agent of the single stage or first stage and simultaneously with or after the addition of the methylating agent of the second stage, if any. The molar ratio between the alkali metal hydroxide of the first stage and the alkali metal hydroxide of the second stage generally is from 0.6:1 to 1.2:1. The alkali metal hydroxide of the second stage is generally added at a temperature of from 55 to 80° C., preferably from 60 to 80° C.

Pressure is then released from the reactor which is flushed with nitrogen to remove unreacted methylating agent

One or more, preferably one or two, hydroxyalkylating agents, such as ethylene oxide and/or propylene oxide are then added to the reaction either before, after, or concurrently with the alkali metal hydroxide added in the second or third stage. Preferably only one hydroxyalkylating agent is used. The hydroxyalkylating agent is generally added in an amount of 0.5 to 2.0 mole of hydroxyalkylating agent per mole of anhydroglucose units. The hydroxyalkylating agent is advantageously added before heating the reaction mixture to the reaction temperature, i.e. at a temperature of from 60 to 80° C.

The resulting hydroxyalkyl methylcellulose is washed to remove salt and other reaction by-products. Any solvent in which salt is soluble may be employed, but water is preferred. The hydroxyalkyl methylcellulose may be washed in the reactor, but is preferably washed in a separate washer located downstream of the reactor. Before or after washing, the hydroxyalkyl methylcellulose may be stripped by exposure to steam to reduce residual organic content.

The hydroxyalkyl methylcellulose is dried to a reduced moisture and volatile content of preferably about 0.5 to about 10.0 weight percent water and more preferably about 0.8 to about 5.0 weight percent water and volatiles, based upon the sum of the weight of hydroxyalkyl methylcellulose and the volatiles. The reduced moisture and volatiles content enables the hydroxyalkyl methylcellulose to be milled into particulate form. The hydroxyalkyl methylcellulose is milled to particulates of desired size. If desired, drying and milling may be carried out simultaneously.

According to the above-mentioned process a hydroxyalkyl methylcellulose is obtained which generally has a viscosity of from 150 mPa·s to 100,000 mPa·s, determined as a 2% by weight aqueous solution at 20° C. in a at a shear rate of 2.51 s⁻¹. For preparing a hydroxyalkyl methylcellulose which is particularly suitable for the production of capsules or coatings of dosage forms, such hydroxyalkyl methylcellulose is generally subjected to a partial depolymerization process. Partial depolymerization processes are well known in the art and described, for example, in European Patent Applications EP 1,141,029; EP 210,917; EP 1,423,433; and U.S. Pat. No. 4,316,982. Alternatively, partial depolymerization can be achieved during the production of the hydroxyalkyl methylcellulose, for example by the presence of oxygen or an oxidizing agent. In such partial depolymerization process a hydroxyalkyl methylcellulose can be obtained which has a viscosity of from 2 to 20 mPa·s, preferably from 3 to 15 mPa·s, determined as a 20% by weight aqueous solution at 20° C. according to ASTM D2363-79 (Reapproved 2006).

In one embodiment, the hydroxyalkyl methylcelluloses of the present invention, particularly hydroxypropyl methylcelluloses, may be useful for preparing solid food compositions which have a higher hardness and/or cohesion than solid food compositions comprising comparable known hydroxyalkyl methylcelluloses, particularly hydroxypropyl methylcelluloses.

The present hydroxyalkyl methylcelluloses are typically incorporated in food compositions at levels of 0.05 to 10 percent, preferably from 0.1 to 8 percent, more preferably from 0.2 to percent, and most preferably from 0.5 to 2 percent, based upon the total weight of the food composition.

The present hydroxyalkyl methylcelluloses are preferably incorporated in solid food compositions, particularly in solid food compositions designed to be heat-treated, such as food compositions to be fried, roasted, grilled, cooked, baked or poached. Preferred food compositions are vegetable, meat, fish and soy patties and balls, vegetable, meat, fish and soy sausages, shaped vegetable, meat, fish and soy products, reformed seafood; reformed cheese sticks; onion rings; pie filling; pasta fillings, heated and baked sweet and savory fillings, starch based fried, baked, grilled, roasted, cooked, baked and poached products, meat analogues, shaped potato products, such as croquettes, pommes duchesses, hash browns, pancakes, waffles, and cakes; chewing sweets, pet foods; leavened and unleavened baked goods, such as breads; and the like. In a preferred aspect of the invention, the food composition is a proteinaceous food composition, particularly proteinaceous vegetarian food, such as soy sausages and patties, meatless meatballs and tofu turkey rolls.

In forming food compositions, the hydroxyalkyl methylcellulose is typically admixed with foodstuffs during the process and formation of the compositions. The food composition of the present invention can be a frozen shaped or pre-cut product, an uncooked premix or a shaped or pre-cut cooked product, such as a fried, roasted, grilled, cooked or poached product. The above-described hydroxyalkyl methylcellulose provides excellent stability of the food composition during and after cooking. The above-described hydroxyalkyl methylcellulose can be the only cellulose ether to be included in the food composition. Alternatively, one or more other cellulose ethers, such as those described in European Patent EP 1 171 471 can also be incorporated in a food composition of the present invention, preferably in a amount of from 0.5 to 2 percent, based on the total weight of the food composition.

In another embodiment, the present hydroxyalkyl methylcelluloses may be included in a composition for the manufacture of an extrusion-molded ceramic body comprising an inorganic material that sets as a result of baking or sintering, the hydroxyalkyl methylcellulose described herein and water.

The inorganic ceramic-forming materials can be synthetically produced materials such as oxides, hydroxides, etc., or they can be naturally occurring minerals such as clays, talcs, or any combination of these. More preferably, the inorganic materials are alumina or a precursor thereof, silica or a precursor thereof, an aluminate, aluminosilicate, alumina silica, feldspar, titania, fused silica, aluminum nitride, aluminum carbide, kaolin, cordierite or a precursor thereof, mullite or a precursor thereof, clay, bentonite, talc, zircon, zirconia, spinel, silicon carbide, silicon boride, silicon nitride, titanium dioxide, titanium carbide, boron carbide, boron oxide, borosilicate, soda barium borosilicate, silicates and sheet silicates, a silicon metal, carbon, ground glass, a rare earth oxide, soda lime, zeolite, barium titanate, lead titanate zirconate, aluminium titanate, barium ferrite, strontium ferrite, carbon, ground glass, metal oxides, such a rare earth oxides, or a combination of two or more of such inorganic materials. The term “clay” means a hydrated aluminum silicate having a platy structure and forms plastic masses when mixed with water. Typically, clays are comprised of one or more crystalline structures such as kaolins, illites and smectites. Preferred oxides are those that form cordierite or mullite when mixed with clay (e.g., silica and talc for forming cordierite and alumina when forming mullite).

The composition for the manufacture of extrusion-molded bodies preferably comprises from 85 to 99.5 percent, more preferably from 90 to 99.3 percent, most preferably from 92 to 99 percent of the inorganic material and from 0.5 to 15 percent, more preferably from 0.7 to 10 percent, most preferably from 1 to 8 percent of the hydroxyalkyl methylcellulose, based on the total weight of the inorganic material and the hydroxyalkyl methylcellulose.

The composition for the manufacture of extrusion-molded bodies preferably is in the form of a paste. Generally it comprises a diluent which is liquid at 25° C. and provides a medium for the hydroxyalkyl methylcellulose to dissolve in thus providing plasticity to the batch and wetting of the powders. The liquid diluent can be aqueous based, which are normally water or water-miscible solvents; or organically based or a mixture thereof. Most preferably water is used. The composition for the manufacture of extrusion-molded bodies preferably comprises from 10 to 60 weight parts, more preferably from 20 to 50 weight parts, most preferably from 15 to 40 weight parts of the liquid diluent per 100 weight parts of the inorganic material.

Uniform mixing of the inorganic material, the hydroxyalkyl methylcellulose, typically a liquid diluent and optionally other additives such as surfactants, lubricants and pore-forming materials can be accomplished by, for example, a known conventional kneading process. The resulting extrudable composition for extrusion-molded bodies is usually stiff and uniform. It can then be shaped into a green body by any known conventional ceramic extrusion process. In an exemplary aspect, extrusion can be done using a hydraulic ram extrusion press, or a two stage de-airing single auger extruder, or a twin screw extruder with a die assembly attached to the discharge end. The prepared green body can then be dried to remove excess moisture. The drying can be performed by hot air, or steam or dielectric drying, which can be followed by air drying. Once dried, the green body can thereafter be fired under conditions effective to convert the green body into a sintered article according to known techniques. The firing conditions of temperature and time depend on the composition and size and geometry of the body, and the invention is not limited to specific firing temperatures and times. Typical temperatures are from 600° C. to 2300° C., and the holding times at these temperatures are typically from 1 hour to 20 hours.

The extrusion-molded bodies according to the present invention can have any convenient size and shape. They find use in a number of applications such as carriers for catalysts, as catalysts, heat exchangers, or filters, for example as diesel particulate filters, molten metal filters and regenerator cores. In a preferred aspect, the composition and the method of the present invention is well suited for the production of cellular bodies such as honeycombs. These cellular ceramic bodies are particularly useful as carriers for catalysts or as catalyst filters for exhaust gas treatment.

Generally honeycomb densities range from about 15 cells/cm² to about 235 cells/cm². Typical wall thicknesses are from 0.05 to 0.65 mm. It should however be understood that the particular desired size and shape of the ceramic body can depend on the application, e.g., in automotive applications by engine size and space available for mounting. Although the extrusion-molded bodies of the instant invention are, in one aspect, suitable for preparing thin-walled honeycombs, the claimed mixtures can also be used for thicker walled structures.

In a further embodiment, the invention relates to an aqueous composition for the manufacture of capsules or coatings of dosage forms which comprises from 7 to 40 weight percent, preferably from 10 to 30 weight percent of the aqueous composition, of a hydroxyalkyl methylcellulose of the present invention that has a viscosity of from 2 to 20 mPa·s, preferably from 3 to 15 mPa·s, determined in a 20% by weight aqueous solution at 20° C. according to ASTM D2363-79 (Reapproved 2006). The aqueous composition may further comprise optional additives, such as coloring agents, flavor and taste improvers, antioxidants, plasticizers, and surfactants. For example, when producing capsules a water-soluble food dye, such as red oxide, or a natural dye, may be used as a coloring agent; TiO₂ may be used as a masking agent; polyethylene glycol, polypropylene glycol, sorbitol or glycerin may be used as a plasticizer or as a surfactant to improve the flexibility of the capsule film. Particularly useful additives for coatings of solid forms are single layer film plasticizers, solids-loading enhancers, a second cellulose ether, surfactants, lubricants, polishing agents, pigments, anti-tack agents, glidants, opacifiers, coloring agents and any combination thereof.

The aqueous composition may be used for coating dosage forms, such as tablets, granules, pellets, caplets, lozenges, suppositories, pessaries or implantable dosage forms, to form a coated composition. Preferred dosage forms are pharmaceutical dosage forms, nutrition supplements or agricultural dosage forms.

Furthermore, the aqueous composition may be used for the manufacture of capsules. One method for the manufacture of capsules is the “hot-pin method”. This method preferably comprises the steps of (a) providing an aqueous composition comprising the above-mentioned low viscosity hydroxyalkyl methylcellulose and optional additives, (b) pre-heating dipping pins so that they are at a temperature above the gelation temperature of the aqueous composition when dipped into the aqueous composition, (c) dipping the pre-heated dipping pins into the aqueous composition maintained at a temperature below its gelation temperature, (d) withdrawing the dipping pins from the aqueous composition obtaining a film on the dipping pins, and (e) drying the film on the dipping pins at a temperature above the gelation temperature of the aqueous composition so as to obtain molded capsule shells on the pins.

In this hot-pin method, the dipping pins are preferably preheated so that they are at a temperature of 55 to 95° C., preferably of 60 to 90° C. when dipped into the aqueous composition. The pre-heated dipping pins are dipped into the aqueous composition that is preferably maintained at a temperature of 10° C. to 1° C., more preferably 4° C. to 1° C. below its gelation temperature. The hot-pin method used to prepare capsules from the aqueous composition of the hydroxyalkyl methylcellulose is described in detail in the International Patent Publication No. WO 2008/050209.

### EXAMPLES

The following examples are for illustrative purposes only and are not intended to limit the scope of the present invention. All percentages are by weight unless otherwise specified.

The determination of the % methoxyl and % hydroxypropoxyl in hydroxypropyl methylcellulose is carried out according to the United States Pharmacopeia (USP 32). The values obtained are % methoxyl and % hydroxypropoxyl. These are subsequently converted into degree of substitution (DS) for methyl substituents and molar substitution (MS) for hydroxypropyl substituents. Residual amounts of salt have been taken into account in the conversion.

The DS(methyl) and MS(hydroxyethyl) in hydroxyethyl methylcellulose is effected by Zeisel cleavage with hydrogen iodide followed by gas chromatography. (G. Bartelmus and R. Ketterer, Z. Anal. Chem. 286 (1977) 161-190).

Determination of s23/s26

The determination of ether substituents in cellulose ethers is generally known and e.g., described in Carbohydrate Research, 176 (1988) 137-144, Elsevier Science Publishers B.V., Amsterdam, DISTRIBUTION OF SUBSTITUENTS IN O-ETHYL-O-(2-HYDROXYETHYL) CELLULOSE by Bengt Lindberg, Ulf Lindquist, and Olle Stenberg.

Specifically, determination of s23/s26 is conducted as follows:

10-12 mg of the cellulose ether are dissolved in 4.0 mL of dry analytical grade dimethyl sulfoxide (DMSO) (Merck, Darmstadt, Germany, stored over 0.3 nm molecular sieve beads) at about 90° C. under stirring and then cooled down to room temperature again. The solution is left stirring at room temperature over night to ensure complete solubilization. The entire reaction including the solubilization of the cellulose ether is performed using a dry nitrogen atmosphere in a 4 mL screw cap vial. After solubilization the dissolved cellulose ether is transferred to a 22 mL screw cap vial. Powdered sodium hydroxide (freshly pestled, analytical grade, Merck, Darmstadt, Germany) and ethyl iodide (for synthesis, stabilized with silver, Merck-Schuchardt, Hohenbrunn, Germany) in a thirty fold molar excess of the reagents sodium hydroxide and ethyl iodide per hydroxyl group of the anhydroglucose unit are added and the solution is vigorously stirred under nitrogen in the dark for three days at ambient temperature. The perethylation is repeated with addition of the threefold amount of the reagents sodium hydroxide and ethyl iodide compared to the first reagent addition and further stirring at room temperature for additional two days.

Optionally the reaction mixture can be diluted with up to 1.5 mL DMSO to ensure good mixing during the course of the reaction. 5 mL of 5% aqueous sodium thiosulfate solution is poured into the reaction mixture and the obtained solution is then extracted three times with 4 mL of dichloromethane. The combined extracts are washed three times with 2 mL of water. The organic phase is dried with anhydrous sodium sulfate (ca. 1 g). After filtration the solvent is removed in a gentle stream of nitrogen and the sample is stored at 4° C. until further sample preparation.

Hydrolysis of about 5 mg of the perethylated samples is performed under nitrogen in a 2 mL screw cap vial with 1 mL of 90% aqueous formic acid under stirring at 100° C. for 1 hour. The acid is removed in a stream of nitrogen at 35-40° C. and the hydrolysis is repeated with 1 mL of 2M aqueous trifluoroacetic acid for 3 hours at 120° C. in an inert nitrogen atmosphere under stirring. After completion the acid is removed to dryness in a stream of nitrogen at ambient temperature using ca. 1 mL of toluene for co-distillation. The residues of the hydrolysis are reduced with 0.5 mL of 0.5 M sodium borodeuteride in 2N aqueous ammonia solution (freshly prepared) for 3 hours at room temperature under stirring. The excess reagent is destroyed by drop wise addition of ca. 200 μL of concentrated acetic acid. The resulting solution is evaporated to dryness in a stream of nitrogen at ca. 35-40° C. and subsequently dried in vacuum for 15 min at room temperature. The viscous residue is dissolved in 0.5 mL of 15% acetic acid in methanol and evaporated to dryness at room temperature. This is done five times and repeated four times with pure methanol. After the final evaporation the sample is dried in vacuum overnight at room temperature.

The residue of the reduction is acetylated with 600 μL of acetic anhydride and 150 μL of pyridine for 3 hrs at 90° C. After cooling the sample vial is filled with toluene and evaporated to dryness in a stream of nitrogen at room temperature. The residue is dissolved in 4 mL of dichloromethane and poured into 2 ml of water and extracted with 2 mL of dichloromethane. The extraction is repeated three times. The combined extracts are washed three times with 4 mL of water and dried with anhydrous sodium sulfate. The dried dichloromethane extract is subsequently submitted to GC analysis. Depending on the sensitivity of the GC system, a further dilution of the extract can be necessary.

Gas-liquid (GLC) chromatographic analyses are performed with Hewlett Packard 5890A and 5890A Series II type of gas chromatographs equipped with J&W capillary columns DB5, 30 m, 0.25 mm ID, 0.25 μm phase layer thickness operated with 1.5 bar helium carrier gas. The gas chromatograph is programmed with a temperature profile that holds constant at 60° C. for 1 min, heats up at a rate of 20° C./min to 200° C., heats further up with a rate of 4° C./min to 250° C., heats further up with a rate of 20° C./min to 310° C. where it is held constant for another 10 min. The injector temperature is set to 280° C. and the temperature of the flame ionization detector (FID) is set to 300° C. 1 μL of the samples is injected in the splitless mode at 0.5 min valve time. Data are acquired and processed with a LabSystems Atlas work station.

Quantitative monomer composition data are obtained from the peak areas measured by GLC with FID detection. Molar responses of the monomers are calculated in line with the effective carbon number (ECN) concept but modified as described in the table below. The effective carbon number (ECN) concept has been described by Ackman (R. G. Ackman, J. Gas Chromatogr., 2 (1964) 173-179 and R. F. Addison, R. G. Ackman, J. Gas Chromatogr., 6 (1968) 135-138) and applied to the quantitative analysis of partially alkylated alditol acetates by Sweet et. al (D. P. Sweet, R. H. Shapiro, P. Albersheim, Carbohyd. Res., 40 (1975) 217-225).

### ECN Increments Used for ECN Calculations:

| Type of carbon atom | ECN increment |
|---|---|
| hydrocarbon | 100 |
| primary alcohol | 55 |
| secondary alcohol | 45 |

In order to correct for the different molar responses of the monomers, the peak areas are multiplied by molar response factors MRFmonomer which are defined as the response relative to the 2,3,6-Me monomer. The 2,3,6-Me monomer is chosen as reference since it is present in all samples analyzed in the determination of s23/s26.

MRFmonomer=ECN2,3,6-Me/ECNmonomer

The mole fractions of the monomers are calculated by dividing the corrected peak areas by the total corrected peak area according to the following formulas:

s23=[(23-Me+23-Me-6-HAMe+23-Me-6-HA+23-Me-6-HAHAMe+23-Me-6-HAHA]; and

s26=[(26-Me+26-Me-3-HAMe+26-Me-3-HA+26-Me-3-HAHAMe+26-Me-3-HAHA],
wherein s23 is the sum of the molar fractions of anhydroglucose units which meet the following conditions:
a) the two hydroxy groups in the 2- and 3-positions of the anhydroglucose unit are substituted with methyl groups and the 6-position is not substituted (=23-Me);
b) the two hydroxy groups in the 2- and 3-positions of the anhydroglucose unit are substituted with methyl groups and the 6-position is substituted with methylated hydroxyalkyl (=23-Me-6-HAMe) or with a methylated side chain comprising 2 hydroxyalkyl groups (=23-Me-6-HAHAMe); and
c) the two hydroxy groups in the 2- and 3-positions of the anhydroglucose unit are substituted with methyl groups and the 6-position is substituted with hydroxyalkyl (=23-Me-6-HA) or with a side chain comprising 2 hydroxyalkyl groups (=23-Me-6-HAHA).

s26 is the sum of the molar fractions of anhydroglucose units which meet the following conditions:
a) the two hydroxy groups in the 2- and 6-positions of the anhydroglucose unit are substituted with methyl groups and the 3-position is not substituted (=26-Me);
b) the two hydroxy groups in the 2- and 6-positions of the anhydroglucose unit are substituted with methyl groups and the 3-position is substituted with methylated hydroxyalkyl (=26-Me-3-HAMe) or with a methylated side chain comprising 2 hydroxyalkyl groups (=26-Me-3-HAHAMe); and
c) the two hydroxy groups in the 2- and 6-positions of the anhydroglucose unit are substituted with methyl groups and the 3-position is substituted with hydroxyalkyl (=26-Me-3-HA) or with a side chain comprising 2 hydroxyalkyl groups (=26-Me-3-HAHA).

The results of the determination of the substituents in the HAMC are listed in Table 4 below. In the case of HPMC's hydroxyalkyl (HA) is hydroxypropyl (HP) and methylated hydroxyalkyl (HAMe) is methylated hydroxypropyl (HPMe).

### Example 1

Hydroxypropyl methylcellulose (HPMC) is produced according to the following procedure. Finely ground wood cellulose pulp is loaded into a jacketed, agitated reactor. The reactor is evacuated and purged with nitrogen to remove oxygen and then evacuated again. The reaction is carried out in two stages. In the first stage a 50 weight percent aqueous solution of sodium hydroxide is sprayed onto the cellulose in an amount of 3.5 moles of sodium hydroxide per mole of anhydroglucose units in the cellulose and the temperature is adjusted to 40° C. After stirring the mixture of aqueous sodium hydroxide solution and cellulose for about 30 minutes at 40° C., 2 moles of dimethyl ether and 3.9 moles of methyl chloride per mole of anhydroglucose units are added to the reactor. The contents of the reactor are then heated in 35 min to 80° C. After having reached 80° C., the first stage reaction is allowed to proceed for 90 min followed by cooling to 70° C. The pressure in the reactor was then released and the reactor was purged twice with nitrogen and vacuum to a final pressure of 5 bar at 70° C.

The second stage of the reaction is started by addition of a 50 weight percent aqueous solution of sodium hydroxide in an amount of 0.5 mole of sodium hydroxide per mole of anhydroglucose units and propyleneoxide in an amount of 1.2 mole of propylene oxide per mole of anhydroglucose units over a period of 10 min. The contents of the reactor was then heated in 10 min. to 80° C. the contents of the reactor were then kept at a temperature of 80° C. for 45 min.

After the reaction, the reactor is vented and cooled down to about 50° C. The contents of the reactor are removed and transferred to a tank containing hot water. The crude HPMC is then neutralized with formic acid and washed chloride free with hot water (assessed by AgNO₃ flocculation test), cooled to room temperature and dried at 55° C. in an air-swept drier. The material is then ground using an Alpine UPZ mill using a 0.5 mm screen.

The resulting HPMC had a DS(methyl) of 1.67, an MS(hydroxypropyl) of 0.11, a s23/s26(methyl) of 0.416 and a s6(hydroxypropyl) of 0.037

### Example 2

Hydroxypropyl methylcellulose (HPMC) is produced according to the following procedure. Finely ground wood cellulose pulp is loaded into a jacketed, agitated reactor. The reactor is evacuated and purged with nitrogen to remove oxygen and then evacuated again. The reaction is carried out in two stages. In the first stage a 50 weight percent aqueous solution of sodium hydroxide is sprayed onto the cellulose in an amount of 3.7 moles of sodium hydroxide per mole of anhydroglucose units in the cellulose and the temperature is adjusted to 40° C. After stirring the mixture of aqueous sodium hydroxide solution and cellulose for about 30 minutes at 40° C., 2 moles of dimethyl ether and 4.1 moles of methyl chloride per mole of anhydroglucose units are added to the reactor. The contents of the reactor are then heated in 35 min to 80° C. After having reached 80° C., the first stage reaction is allowed to proceed for 90 min followed by cooling to 70° C. The pressure in the reactor was then released and the reactor was purged twice with nitrogen and vacuum to a final pressure of 5 bar at 70° C.

The second stage of the reaction is started by addition of a 50 weight percent aqueous solution of sodium hydroxide in an amount of 0.5 mole of sodium hydroxide per mole of anhydroglucose units and propyleneoxide in an amount of 1.2 mole of propylene oxide per mole of anhydroglucose units over a period of 10 min. The contents of the reactor was then heated in 10 min. to 80° C. the contents of the reactor were then kept at a temperature of 80° C. for 45 min.

After the reaction, the reactor is vented and cooled down to about 50° C. The contents of the reactor are removed and transferred to a tank containing hot water. The crude HPMC is then neutralized with formic acid and washed chloride free with hot water (assessed by AgNO₃ flocculation test), cooled to room temperature and dried at 55° C. in an air-swept drier. The material is then ground using an Alpine UPZ mill using a 0.5 mm screen.

The resulting HPMC had a DS(methyl) of 1.71, an MS(hydroxypropyl) of 0.09, a s23/s26(methyl) of 0.399 and a s6(hydroxypropyl) of 0.031

### Example 3

Hydroxypropyl methylcellulose (HPMC) is produced according to the following procedure. Finely ground wood cellulose pulp is loaded into a jacketed, agitated reactor. The reactor is evacuated and purged with nitrogen to remove oxygen and then evacuated again. The reaction is carried out in two stages. In the first stage a 50 weight percent aqueous solution of sodium hydroxide is sprayed onto the cellulose in an amount of 3.9 moles of sodium hydroxide per mole of anhydroglucose units in the cellulose and the temperature is adjusted to 40° C. After stirring the mixture of aqueous sodium hydroxide solution and cellulose for about 30 minutes at 40° C., 2 moles of dimethyl ether and 4.3 moles of methyl chloride per mole of anhydroglucose units are added to the reactor. The contents of the reactor are then heated in 35 min to 80° C. After having reached 80° C., the first stage reaction is allowed to proceed for 90 min followed by cooling to 70° C. The pressure in the reactor was then released and the reactor was purged twice with nitrogen and vacuum to a final pressure of 5 bar at 70° C.

The second stage of the reaction is started by addition of a 50 weight percent aqueous solution of sodium hydroxide in an amount of 0.5 mole of sodium hydroxide per mole of anhydroglucose units and propyleneoxide in an amount of 1.2 mole of propylene oxide per mole of anhydroglucose units over a period of 10 min. The contents of the reactor was then heated in 10 min. to 80° C. the contents of the reactor were then kept at a temperature of 80° C. for 45 min.

After the reaction, the reactor is vented and cooled down to about 50° C. The contents of the reactor are removed and transferred to a tank containing hot water. The crude HPMC is then neutralized with formic acid and washed chloride free with hot water (assessed by AgNO₃ flocculation test), cooled to room temperature and dried at 55° C. in an air-swept drier. The material is then ground using an Alpine UPZ mill using a 0.5 mm screen.

The resulting HPMC had a DS(methyl) of 1.75, an MS(hydroxypropyl) of 0.08, a s23/s26(methyl) of 0.465 and a s6(hydroxypropyl) of 0.027

### Example 4

Hydroxypropyl methylcellulose (HPMC) is produced according to the following procedure. Finely ground wood cellulose pulp is loaded into a jacketed, agitated reactor. The reactor is evacuated and purged with nitrogen to remove oxygen and then evacuated again. The reaction is carried out in two stages. In the first stage a 50 weight percent aqueous solution of sodium hydroxide is sprayed onto the cellulose in an amount of 3.5 moles of sodium hydroxide per mole of anhydroglucose units in the cellulose and the temperature is adjusted to 40° C. After stirring the mixture of aqueous sodium hydroxide solution and cellulose for about 30 minutes at 40° C., 2 moles of dimethyl ether and 3.9 moles of methyl chloride per mole of anhydroglucose units are added to the reactor. The contents of the reactor are then heated in 35 min to 80° C. After having reached 80° C., the first stage reaction is allowed to proceed for 90 min followed by cooling to 70° C. The pressure in the reactor was then released and the reactor was purged twice with nitrogen and vacuum to a final pressure of 5 bar at 70° C.

The second stage of the reaction is started by addition of a 50 weight percent aqueous solution of sodium hydroxide in an amount of 0.5 mole of sodium hydroxide per mole of anhydroglucose units and propyleneoxide in an amount of 0.8 mole of propylene oxide per mole of anhydroglucose units over a period of 10 min. The contents of the reactor was then heated in 10 min. to 80° C. the contents of the reactor were then kept at a temperature of 80° C. for 45 min.

After the reaction, the reactor is vented and cooled down to about 50° C. The contents of the reactor are removed and transferred to a tank containing hot water. The crude HPMC is then neutralized with formic acid and washed chloride free with hot water (assessed by AgNO₃ flocculation test), cooled to room temperature and dried at 55° C. in an air-swept drier. The material is then ground using an Alpine UPZ mill using a 0.5 mm screen.

The resulting HPMC had a DS(methyl) of 1.67, an MS(hydroxypropyl) of 0.07, a s23/s26(methyl) of 0.417 and a s6(hydroxypropyl) of 0.027.

### Example 5

Hydroxypropyl methylcellulose (HPMC) is produced according to the following procedure. Finely ground wood cellulose pulp is loaded into a jacketed, agitated reactor. The reactor is evacuated and purged with nitrogen to remove oxygen and then evacuated again. The reaction is carried out in two stages. In the first stage a 50 weight percent aqueous solution of sodium hydroxide is sprayed onto the cellulose in an amount of 3.9 moles of sodium hydroxide per mole of anhydroglucose units in the cellulose and the temperature is adjusted to 40° C. After stirring the mixture of aqueous sodium hydroxide solution and cellulose for about 30 minutes at 40° C., 2 moles of dimethyl ether and 4.3 moles of methyl chloride per mole of anhydroglucose units are added to the reactor. The contents of the reactor are then heated in 35 min to 80° C. After having reached 80° C., the first stage reaction is allowed to proceed for 90 min followed by cooling to 70° C. The pressure in the reactor was then released and the reactor was purged twice with nitrogen and vacuum to a final pressure of 5 bar at 70° C.

The second stage of the reaction is started by addition of a 50 weight percent aqueous solution of sodium hydroxide in an amount of 0.5 mole of sodium hydroxide per mole of anhydroglucose units and propyleneoxide in an amount of 0.8 mole of propylene oxide per mole of anhydroglucose units over a period of 10 min. The contents of the reactor was then heated in 10 min. to 80° C. the contents of the reactor were then kept at a temperature of 80° C. for 45 min.

After the reaction, the reactor is vented and cooled down to about 50° C. The contents of the reactor are removed and transferred to a tank containing hot water. The crude HPMC is then neutralized with formic acid and washed chloride free with hot water (assessed by AgNO₃ flocculation test), cooled to room temperature and dried at 55° C. in an air-swept drier. The material is then ground using an Alpine UPZ mill using a 0.5 mm screen.

The resulting HPMC had a DS(methyl) of 1.76, an MS(hydroxypropyl) of 0.05, a s23/s26(methyl) of 0.406 and a s6(hydroxypropyl) of 0.018

### Example 6

Hydroxypropyl methylcellulose (HPMC) is produced according to the following procedure. Finely ground wood cellulose pulp is loaded into a jacketed, agitated reactor. The reactor is evacuated and purged with nitrogen to remove oxygen and then evacuated again. The reaction is carried out in two stages. In the first stage a 50 weight percent aqueous solution of sodium hydroxide is sprayed onto the cellulose in an amount of 2.8 moles of sodium hydroxide per mole of anhydroglucose units in the cellulose and the temperature is adjusted to 40° C. After stirring the mixture of aqueous sodium hydroxide solution and cellulose for about 30 minutes at 40° C., 2 moles of dimethyl ether and 3.2 moles of methyl chloride per mole of anhydroglucose units are added to the reactor. The contents of the reactor are then heated in 35 min to 70° C. After having reached 70° C., the first stage reaction is allowed to proceed for 90 min. The pressure in the reactor was then released and the reactor was purged twice with nitrogen.

The second stage of the reaction is started by addition of a 50 weight percent aqueous solution of sodium hydroxide in an amount of 1.3 mole of sodium hydroxide per mole of anhydroglucose units which was reacted for 10 min. at 70° C. followed by addition of propyleneoxide in an amount of 1.0 mole of propylene oxide per mole of anhydroglucose units over a period of 10 min. The contents of the reactor were then then kept at a temperature of 70° C. for 40 min.

After the reaction, the reactor is vented and cooled down to about 50° C. The contents of the reactor are removed and transferred to a tank containing hot water. The crude HPMC is then neutralized with formic acid and washed chloride free with hot water (assessed by AgNO₃ flocculation test), cooled to room temperature and dried at 55° C. in an air-swept drier. The material is then ground using an Alpine UPZ mill using a 0.5 mm screen.

The resulting HPMC had a DS(methyl) of 1.19, an MS(hydroxypropyl) of 0.21, a s23/s26(methyl) of 0.484 and a s6(hydroxypropyl) of 0.066.

### Example 7

Hydroxypropyl methylcellulose (HPMC) is produced according to the following procedure. Finely ground wood cellulose pulp is loaded into a jacketed, agitated reactor. The reactor is evacuated and purged with nitrogen to remove oxygen and then evacuated again. The reaction is carried out in two stages. In the first stage a 50 weight percent aqueous solution of sodium hydroxide is sprayed onto the cellulose in an amount of 3.5 moles of sodium hydroxide per mole of anhydroglucose units in the cellulose and the temperature is adjusted to 40° C. After stirring the mixture of aqueous sodium hydroxide solution and cellulose for about 30 minutes at 40° C., 2 moles of dimethyl ether and 3.9 moles of methyl chloride per mole of anhydroglucose units are added to the reactor. The contents of the reactor are then heated in 35 min to 70° C. After having reached 70° C., the first stage reaction is allowed to proceed for 90 min. The pressure in the reactor was then released and the reactor was purged twice with nitrogen.

The second stage of the reaction is started by addition of a 50 weight percent aqueous solution of sodium hydroxide in an amount of 1.3 mole of sodium hydroxide per mole of anhydroglucose units which was reacted for 10 min. at 70° C. followed by addition of propyleneoxide in an amount of 1.0 mole of propylene oxide per mole of anhydroglucose units over a period of 10 min. The contents of the reactor were then kept at a temperature of 70° C. for 40 min.

After the reaction, the reactor is vented and cooled down to about 50° C. The contents of the reactor are removed and transferred to a tank containing hot water. The crude HPMC is then neutralized with formic acid and washed chloride free with hot water (assessed by AgNO₃ flocculation test), cooled to room temperature and dried at 55° C. in an air-swept drier. The material is then ground using an Alpine UPZ mill using a 0.5 mm screen.

The resulting HPMC had a DS(methyl) of 1.3, an MS(hydroxypropyl) of 0.16, a s23/s26(methyl) of 0.475 and a s6(hydroxypropyl) of 0.05.

### Example 8

Hydroxypropyl methylcellulose (HPMC) is produced according to the following procedure. Finely ground wood cellulose pulp is loaded into a jacketed, agitated reactor. The reactor is evacuated and purged with nitrogen to remove oxygen and then evacuated again. The reaction is carried out in two stages. In the first stage a 50 weight percent aqueous solution of sodium hydroxide is sprayed onto the cellulose in an amount of 1.2 moles of sodium hydroxide per mole of anhydroglucose units in the cellulose and the temperature is adjusted to 40° C. After stirring the mixture of aqueous sodium hydroxide solution and cellulose for about 30 minutes at 40° C., 1.5 moles of dimethyl ether and 1.6 moles of methyl chloride per mole of anhydroglucose units are added to the reactor. The contents of the reactor are then heated in 35 min to 80° C. After having reached 80° C., the first stage reaction is allowed to proceed for 15 min. and the contents of the reactor are cooled down to 60° C. in 15 min.

The second stage of the reaction is started by addition of a 50 weight percent aqueous solution of sodium hydroxide at an amount of 1.5 moles of sodium hydroxide per mole of anhydroglucose units and methyl chloride in an amount of 1.8 molar equivalents of methyl chloride per mole of anhydroglucose units. The contents of the reactor are then heated to 80° C. in 20 min. and kept at a temperature of 80° C. for 30 min. followed by cooling to 70° C. The pressure in the reactor was then released and the reactor was purged twice with nitrogen and vacuum to a final pressure of 5 bar at 70° C.

The third stage of the reaction is started by addition of a 50 weight percent aqueous solution of sodium hydroxide in an amount of 0.5 mole of sodium hydroxide per mole of anhydroglucose units and propyleneoxide in an amount of 0.8 mole of propylene oxide per mole of anhydroglucose units over a period of 10 min. The contents of the reactor was then heated in 10 min. to 80° C. the contents of the reactor were then kept at a temperature of 80° C. for 45 min.

After the reaction, the reactor is vented and cooled down to about 50° C. The contents of the reactor are removed and transferred to a tank containing hot water. The crude HPMC is then neutralized with formic acid and washed chloride free with hot water (assessed by AgNO₃ flocculation test), cooled to room temperature and dried at 55° C. in an air-swept drier. The material is then ground using an Alpine UPZ mill using a 0.5 mm screen.

The resulting HPMC had a DS(methyl) of 1.26, an MS(hydroxypropyl) of 0.17, a s23/s26(methyl) of 0.469 and a s6(hydroxypropyl) of 0.055.

### Example 9

Hydroxypropyl methylcellulose (HPMC) is produced according to the following procedure. Finely ground wood cellulose pulp is loaded into a jacketed, agitated reactor. The reactor is evacuated and purged with nitrogen to remove oxygen and then evacuated again. The reaction is carried out in two stages. In the first stage a 50 weight percent aqueous solution of sodium hydroxide is sprayed onto the cellulose in an amount of 1.4 moles of sodium hydroxide per mole of anhydroglucose units in the cellulose and the temperature is adjusted to 40° C. After stirring the mixture of aqueous sodium hydroxide solution and cellulose for about 30 minutes at 40° C., 1.5 moles of dimethyl ether and 1.8 moles of methyl chloride per mole of anhydroglucose units are added to the reactor. The contents of the reactor are then heated in 35 min to 80° C. After having reached 80° C., the first stage reaction is allowed to proceed for 15 min. and the contents of the reactor are cooled down to 60° C. in 15 min.

The second stage of the reaction is started by addition of a 50 weight percent aqueous solution of sodium hydroxide at an amount of 1.5 moles of sodium hydroxide per mole of anhydroglucose units and methyl chloride in an amount of 1.8 molar equivalents of methyl chloride per mole of anhydroglucose units. The contents of the reactor are then heated to 80° C. in 20 min. and kept at a temperature of 80° C. for 30 min. followed by cooling to 70° C. The pressure in the reactor was then released and the reactor was purged twice with nitrogen and vacuum to a final pressure of 5 bar at 70° C.

The third stage of the reaction is started by addition of a 50 weight percent aqueous solution of sodium hydroxide in an amount of 0.5 mole of sodium hydroxide per mole of anhydroglucose units and propyleneoxide in an amount of 0.8 mole of propylene oxide per mole of anhydroglucose units over a period of 10 min. The contents of the reactor was then heated in 10 min. to 80° C. the contents of the reactor were then kept at a temperature of 80° C. for 45 min.

After the reaction, the reactor is vented and cooled down to about 50° C. The contents of the reactor are removed and transferred to a tank containing hot water. The crude HPMC is then neutralized with formic acid and washed chloride free with hot water (assessed by AgNO₃ flocculation test), cooled to room temperature and dried at 55° C. in an air-swept drier. The material is then ground using an Alpine UPZ mill using a 0.5 mm screen.

The resulting HPMC had a DS(methyl) of 1.37, an MS(hydroxypropyl) of 0.14, a s23/s26(methyl) of 0.446 and a s6(hydroxypropyl) of 0.042.

### Example 10

Hydroxypropyl methylcellulose (HPMC) is produced according to the following procedure. Finely ground wood cellulose pulp is loaded into a jacketed, agitated reactor. The reactor is evacuated and purged with nitrogen to remove oxygen and then evacuated again. The reaction is carried out in two stages. In the first stage a 50 weight percent aqueous solution of sodium hydroxide is sprayed onto the cellulose in an amount of 1.6 moles of sodium hydroxide per mole of anhydroglucose units in the cellulose and the temperature is adjusted to 40° C. After stirring the mixture of aqueous sodium hydroxide solution and cellulose for about 30 minutes at 40° C., 1.5 moles of dimethyl ether and 2.0 moles of methyl chloride per mole of anhydroglucose units are added to the reactor. The contents of the reactor are then heated in 35 min to 80° C. After having reached 80° C., the first stage reaction is allowed to proceed for 15 min. and the contents of the reactor are cooled down to 60° C. in 15 min.

The second stage of the reaction is started by addition of a 50 weight percent aqueous solution of sodium hydroxide at an amount of 1.5 moles of sodium hydroxide per mole of anhydroglucose units and methyl chloride in an amount of 1.8 molar equivalents of methyl chloride per mole of anhydroglucose units. The contents of the reactor are then heated to 80° C. in 20 min. and kept at a temperature of 80° C. for 30 min. followed by cooling to 70° C. The pressure in the reactor was then released and the reactor was purged twice with nitrogen and vacuum to a final pressure of 5 bar at 70° C.

The third stage of the reaction is started by addition of a 50 weight percent aqueous solution of sodium hydroxide in an amount of 0.5 mole of sodium hydroxide per mole of anhydroglucose units and propyleneoxide in an amount of 0.8 mole of propylene oxide per mole of anhydroglucose units over a period of 10 min. The contents of the reactor was then heated in 10 min. to 80° C. the contents of the reactor were then kept at a temperature of 80° C. for 45 min.

After the reaction, the reactor is vented and cooled down to about 50° C. The contents of the reactor are removed and transferred to a tank containing hot water. The crude HPMC is then neutralized with formic acid and washed chloride free with hot water (assessed by AgNO₃ flocculation test), cooled to room temperature and dried at 55° C. in an air-swept drier. The material is then ground using an Alpine UPZ mill using a 0.5 mm screen.

The resulting HPMC had a DS(methyl) of 1.52, an MS(hydroxypropyl) of 0.12, a s23/s26(methyl) of 0.418 and a s6(hydroxypropyl) of 0.051.

### Example 11

Hydroxypropyl methylcellulose (HPMC) is produced according to the following procedure. Finely ground wood cellulose pulp is loaded into a jacketed, agitated reactor. The reactor is evacuated and purged with nitrogen to remove oxygen and then evacuated again. The reaction is carried out in two stages. In the first stage a 50 weight percent aqueous solution of sodium hydroxide is sprayed onto the cellulose in an amount of 1.2 moles of sodium hydroxide per mole of anhydroglucose units in the cellulose and the temperature is adjusted to 40° C. After stirring the mixture of aqueous sodium hydroxide solution and cellulose for about 30 minutes at 40° C., 1.5 moles of dimethyl ether and 1.6 moles of methyl chloride per mole of anhydroglucose units are added to the reactor. The contents of the reactor are then heated in 35 min to 80° C. After having reached 80° C., the first stage reaction is allowed to proceed for 15 min. and the contents of the reactor are cooled down to 60° C. in 15 min.

The second stage of the reaction is started by addition of a 50 weight percent aqueous solution of sodium hydroxide at an amount of 1.5 moles of sodium hydroxide per mole of anhydroglucose units and methyl chloride in an amount of 1.8 molar equivalents of methyl chloride per mole of anhydroglucose units. The contents of the reactor are then heated to 80° C. in 20 min. and kept at a temperature of 80° C. for 30 min. followed by cooling to 70° C. The pressure in the reactor was then released and the reactor was purged twice with nitrogen and vacuum to a final pressure of 5 bar at 70° C.

The third stage of the reaction is started by addition of a 50 weight percent aqueous solution of sodium hydroxide in an amount of 0.5 mole of sodium hydroxide per mole of anhydroglucose units and propyleneoxide in an amount of 1.2 mole of propylene oxide per mole of anhydroglucose units over a period of 10 min. The contents of the reactor was then heated in 10 min. to 80° C. the contents of the reactor were then kept at a temperature of 80° C. for 45 min.

After the reaction, the reactor is vented and cooled down to about 50° C. The contents of the reactor are removed and transferred to a tank containing hot water. The crude HPMC is then neutralized with formic acid and washed chloride free with hot water (assessed by AgNO₃ flocculation test), cooled to room temperature and dried at 55° C. in an air-swept drier. The material is then ground using an Alpine UPZ mill using a 0.5 mm screen.

The resulting HPMC had a DS(methyl) of 1.22, an MS(hydroxypropyl) of 0.26, a s23/s26(methyl) of 0.437 and a s6(hydroxypropyl) of 0.072.

### Example 12

Hydroxypropyl methylcellulose (HPMC) is produced according to the following procedure. Finely ground wood cellulose pulp is loaded into a jacketed, agitated reactor. The reactor is evacuated and purged with nitrogen to remove oxygen and then evacuated again. The reaction is carried out in two stages. In the first stage a 50 weight percent aqueous solution of sodium hydroxide is sprayed onto the cellulose in an amount of 1.6 moles of sodium hydroxide per mole of anhydroglucose units in the cellulose and the temperature is adjusted to 40° C. After stirring the mixture of aqueous sodium hydroxide solution and cellulose for about 30 minutes at 40° C., 1.5 moles of dimethyl ether and 2.0 moles of methyl chloride per mole of anhydroglucose units are added to the reactor. The contents of the reactor are then heated in 35 min to 80° C. After having reached 80° C., the first stage reaction is allowed to proceed for 15 min. and the contents of the reactor are cooled down to 60° C. in 15 min.

The second stage of the reaction is started by addition of a 50 weight percent aqueous solution of sodium hydroxide at an amount of 1.5 moles of sodium hydroxide per mole of anhydroglucose units and methyl chloride in an amount of 1.8 molar equivalents of methyl chloride per mole of anhydroglucose units. The contents of the reactor are then heated to 80° C. in 20 min. and kept at a temperature of 80° C. for 30 min. followed by cooling to 70° C. The pressure in the reactor was then released and the reactor was purged twice with nitrogen and vacuum to a final pressure of 5 bar at 70° C.

The third stage of the reaction is started by addition of a 50 weight percent aqueous solution of sodium hydroxide in an amount of 0.5 mole of sodium hydroxide per mole of anhydroglucose units and propyleneoxide in an amount of 1.2 mole of propylene oxide per mole of anhydroglucose units over a period of 10 min. The contents of the reactor was then heated in 10 min. to 80° C. the contents of the reactor were then kept at a temperature of 80° C. for 45 min.

After the reaction, the reactor is vented and cooled down to about 50° C. The contents of the reactor are removed and transferred to a tank containing hot water. The crude HPMC is then neutralized with formic acid and washed chloride free with hot water (assessed by AgNO₃ flocculation test), cooled to room temperature and dried at 55° C. in an air-swept drier. The material is then ground using an Alpine UPZ mill using a 0.5 mm screen.

The resulting HPMC had a DS(methyl) of 1.49, an MS(hydroxypropyl) of 0.18, a s23/s26(methyl) of 0.429 and a s6(hydroxypropyl) of 0.039.

### Example 13

Hydroxypropyl methylcellulose (HPMC) is produced according to the following procedure. Finely ground wood cellulose pulp is loaded into a jacketed, agitated reactor. The reactor is evacuated and purged with nitrogen to remove oxygen and then evacuated again. The reaction is carried out in two stages. In the first stage a 50 weight percent aqueous solution of sodium hydroxide is sprayed onto the cellulose in an amount of 1.2 moles of sodium hydroxide per mole of anhydroglucose units in the cellulose and the temperature is adjusted to 40° C. After stirring the mixture of aqueous sodium hydroxide solution and cellulose for about 30 minutes at 40° C., 1.5 moles of dimethyl ether and 1.6 moles of methyl chloride per mole of anhydroglucose units are added to the reactor. The contents of the reactor are then heated in 35 min to 80° C. After having reached 80° C., the first stage reaction is allowed to proceed for 15 min. and the contents of the reactor are cooled down to 70° C. in 15 min.

The second stage of the reaction is started by addition of a 50 weight percent aqueous solution of sodium hydroxide at an amount of 1.2 moles of sodium hydroxide per mole of anhydroglucose units and methyl chloride in an amount of 1.44 molar equivalents of methyl chloride per mole of anhydroglucose units. The contents of the reactor are then heated to 80° C. in 18 min. and kept at a temperature of 80° C. for 26 min. followed by cooling to 70° C. The pressure in the reactor was then released and the reactor was purged three times with nitrogen at 70° C.

The third stage of the reaction is started by addition of a 50 weight percent aqueous solution of sodium hydroxide in an amount of 1.3 mole of sodium hydroxide per mole of anhydroglucose units which was reacted for 10 min. at 70° C. followed by addition of propyleneoxide in an amount of 1.0 mole of propylene oxide per mole of anhydroglucose units over a period of 10 min. The contents of the reactor were then kept at a temperature of 70° C. for 40 min.

After the reaction, the reactor is vented and cooled down to about 50° C. The contents of the reactor are removed and transferred to a tank containing hot water. The crude HPMC is then neutralized with formic acid and washed chloride free with hot water (assessed by AgNO₃ flocculation test), cooled to room temperature and dried at 55° C. in an air-swept drier. The material is then ground using an Alpine UPZ mill using a 0.5 mm screen.

The resulting HPMC had a DS(methyl) of 1.18, an MS(hydroxypropyl) of 0.24, a s23/s26(methyl) of 0.385 and a s6(hydroxypropyl) of 0.075.

### Example 14

Hydroxypropyl methylcellulose (HPMC) is produced according to the following procedure. Finely ground wood cellulose pulp is loaded into a jacketed, agitated reactor. The reactor is evacuated and purged with nitrogen to remove oxygen and then evacuated again. The reaction is carried out in two stages. In the first stage a 50 weight percent aqueous solution of sodium hydroxide is sprayed onto the cellulose in an amount of 1.5 moles of sodium hydroxide per mole of anhydroglucose units in the cellulose and the temperature is adjusted to 40° C. After stirring the mixture of aqueous sodium hydroxide solution and cellulose for about 30 minutes at 40° C., 1.5 moles of dimethyl ether and 2.0 moles of methyl chloride per mole of anhydroglucose units are added to the reactor. The contents of the reactor are then heated in 35 min to 80° C. After having reached 80° C., the first stage reaction is allowed to proceed for 15 min. and the contents of the reactor are cooled down to 70° C. in 15 min.

The second stage of the reaction is started by addition of a 50 weight percent aqueous solution of sodium hydroxide at an amount of 1.5 moles of sodium hydroxide per mole of anhydroglucose units and methyl chloride in an amount of 1.8 molar equivalents of methyl chloride per mole of anhydroglucose units. The contents of the reactor are then heated to 80° C. in 18 min. and kept at a temperature of 80° C. for 16 min. followed by cooling to 70° C. The pressure in the reactor was then released and the reactor was purged three times with nitrogen at 70° C.

The third stage of the reaction is started by addition of a 50 weight percent aqueous solution of sodium hydroxide in an amount of 1.3 mole of sodium hydroxide per mole of anhydroglucose units which was reacted fpr 10 min. at 70° C. followed by addition of propyleneoxide in an amount of 0.9 mole of propylene oxide per mole of anhydroglucose units over a period of 10 min. The contents of the reactor were then kept at a temperature of 70° C. for 40 min.

After the reaction, the reactor is vented and cooled down to about 50° C. The contents of the reactor are removed and transferred to a tank containing hot water. The crude HPMC is then neutralized with formic acid and washed chloride free with hot water (assessed by AgNO₃ flocculation test), cooled to room temperature and dried at 55° C. in an air-swept drier. The material is then ground using an Alpine UPZ mill using a 0.5 mm screen.

The resulting HPMC had a DS(methyl) of 1.47, an MS(hydroxypropyl) of 0.14, a s23/s26(methyl) of 0.385 and a s6(hydroxypropyl) of 0.046.

### Example 15

Hydroxypropyl methylcellulose (HPMC) is produced according to the following procedure. Finely ground wood cellulose pulp is loaded into a jacketed, agitated reactor. The reactor is evacuated and purged with nitrogen to remove oxygen and then evacuated again. The reaction is carried out in two stages. In the first stage a 50 weight percent aqueous solution of sodium hydroxide is sprayed onto the cellulose in an amount of 1.5 moles of sodium hydroxide per mole of anhydroglucose units in the cellulose and the temperature is adjusted to 40° C. After stirring the mixture of aqueous sodium hydroxide solution and cellulose for about 30 minutes at 40° C., 1.5 moles of dimethyl ether and 2.0 moles of methyl chloride per mole of anhydroglucose units are added to the reactor. The contents of the reactor are then heated in 35 min to 80° C. After having reached 80° C., the first stage reaction is allowed to proceed for 15 min. and the contents of the reactor are cooled down to 70° C. in 15 min.

The second stage of the reaction is started by addition of a 50 weight percent aqueous solution of sodium hydroxide at an amount of 1.5 moles of sodium hydroxide per mole of anhydroglucose units and methyl chloride in an amount of 1.8 molar equivalents of methyl chloride per mole of anhydroglucose units. The contents of the reactor are then heated to 80° C. in 18 min. and kept at a temperature of 80° C. for 26 min. followed by cooling to 70° C. The pressure in the reactor was then released and the reactor was purged three times with nitrogen at 70° C.

The third stage of the reaction is started by addition of a 50 weight percent aqueous solution of sodium hydroxide in an amount of 1.3 mole of sodium hydroxide per mole of anhydroglucose units which was reacted for 10 min. at 70° C. followed by addition of propyleneoxide in an amount of 0.9 mole of propylene oxide per mole of anhydroglucose units over a period of 10 min. The contents of the reactor were then kept at a temperature of 70° C. for 40 min.

After the reaction, the reactor is vented and cooled down to about 50° C. The contents of the reactor are removed and transferred to a tank containing hot water. The crude HPMC is then neutralized with formic acid and washed chloride free with hot water (assessed by AgNO₃ flocculation test), cooled to room temperature and dried at 55° C. in an air-swept drier. The material is then ground using an Alpine UPZ mill using a 0.5 mm screen.

The resulting HPMC had a DS(methyl) of 1.49, an MS(hydroxypropyl) of 0.13, a s23/s26(methyl) of 0.363 and a s6(hydroxypropyl) of 0.043.

### Example 16

### Determination of the Viscosity of Aqueous Solutions of the Present HPMCs

To achieve homogenous solutions, 4 g of the HPMC powder (under consideration of the water content of the HPMC) is suspended in 196 g water at 70° C. with an overhead laboratory stirrer at 700 rpm for 10 min. These solutions are then cooled to a temperature<5° C. for 2 hours to complete the dissolution process. During these 2 hours the solutions are stirred at 500-1000 rpm and lost water due to evaporation is replaced. These solutions are then stored in a refrigerator overnight.

The viscosities of the hydroxypropyl methylcellulose is determined in a 2% by weight aqueous solution at 20° C. in a Anton Paar Physica MCR 501 rheometer with a cup & bob Geometry (CC-27) at 20° C. and at a shear rate of 2.51 s⁻¹.

### Determination of Storage Modulus G′, Loss Modulus G″, Gelation Temperature t and Gel Strength

To characterize the temperature dependent properties of the gelation of a 2 weight percent aqueous cellulose ether solution, an Anton Paar Physica MCR 501 rheometer (Ostfildern, Germany) with a Cup & Bob set-up (CC-27) and a peltier temperature control system is used in oscillation shear flow. These solutions are prepared according to the same dissolution procedure as described for the viscosity measurements. The measurements are performed at a constant frequency of 2 Hz. and a constant strain (deformation amplitude) of 0.5% from 10° C. to 85° C. with a heating rate of 1° C./min with a data collection rate of 4 points/min. The storage modulus G′, which is obtained from the oscillation measurements, represents the elastic properties of the solution. The loss modulus G″, which is obtained from the oscillation measurements, represents the viscous properties of the solution. At low temperature the loss modulus values G″ are higher than the storage modulus G′. At increasing temperatures the storage modulus values are increasing and a cross-over between the storage modulus and the loss modulus is obtained. The cross-over of G′ and G″ is determined to be the gelation temperature.

The viscosity, gelation temperature and storage modulus G′ for Examples 1-15 are shown in Table 1 below.

TABLE 1

| | Example 1 | Example 2 | Example 3 | Example 4 | Example 5 | Example 8 | Example 9 | Example 10 | Example 11 | Example 12 |
|---|---|---|---|---|---|---|---|---|---|---|
| DS (Me) | 1.67 | 1.71 | 1.75 | 1.67 | 1.76 | 1.26 | 1.37 | 1.52 | 1.22 | 1.49 |
| MS (HP) | 0.11 | 0.09 | 0.08 | 0.07 | 0.05 | 0.17 | 0.14 | 0.12 | 0.26 | 0.18 |
| Viscosity (2%) at | 3970 | 6870 | 7060 | 4850 | 7090 | 2140 | 2800 | 4830 | 1710 | 3190 |
| 2.51 s − 1 | | | | | | | | | | |
| Gel Temp | 61.4 | 61.4 | 56.9 | 59.1 | 56.9 | 69.6 | 66.1 | 59.3 | 70.1 | 62.4 |
| (G′ = G″) | | | | | | | | | | |
| G′ (65° C.) | 57.8 | 85.3 | 194 | 135 | 346 | 3.34 | 4.57 | 60 | 0.812 | 25.4 |
| G′ (70° C.) | 311 | 556 | 697 | 593 | 1110 | 5.27 | 38.8 | 194 | 2.7 | 113 |
| G′ (75° C.) | 659 | 994 | 1060 | 1070 | 1590 | 33.3 | 150 | 442 | 39.7 | 282 |
| G′ (80° C.) | 916 | 1340 | 1510 | 1440 | 2090 | 117 | 307 | 695 | 92.6 | 445 |
| G′ (85° C.) | 1320 | 1770 | 2190 | 1930 | 2800 | 223 | 406 | 898 | 98.3 | 604 |
| s23/s26 (O—Me) | 0.416 | 0.399 | 0.405 | 0.417 | 0.406 | 0.469 | 0.446 | 0.418 | 0.437 | 0.429 |
| s6 (O—HP) | 0.037 | 0.031 | 0.027 | 0.027 | 0.018 | 0.055 | 0.042 | 0.051 | 0.072 | 0.039 |

| | Example 6 | Example 7 | Example 13 | Example 14 | Example 15 |
|---|---|---|---|---|---|
| DS (Me) | 1.19 | 1.3 | 1.18 | 1.47 | 1.49 |
| MS (HP) | 0.21 | 0.16 | 0.24 | 0.14 | 0.13 |
| Viscosity (2%) at | 2220 | 2070 | 1370 | 2350 | 2250 |
| 2.51 s − 1 | | | | | |
| Gel Temp | 79.7 | 73.5 | 67.5 | 61 | 59.7 |
| (G′ = G″) | | | | | |
| G′ (65° C.) | 0.6 | 0.60 | 1 | 97 | 184 |
| G′ (70° C.) | 0.5 | 1 | 17 | 353 | 471 |
| G′ (75° C.) | 0.5 | 9 | 105 | 508 | 602 |
| G′ (80° C.) | 1.8 | 63 | 158 | 568 | 674 |
| G′ (85° C.) | 26.0 | 72 | 167 | 633 | 778 |
| s23/s26 (O—Me) | 0.484 | 0.475 | 0.385 | 0.385 | 0.363 |
| s6 (O—HP) | 0.066 | 0.050 | 0.075 | 0.046 | 0.043 |

1. A hydroxyalkyl methylcellulose wherein the substitution pattern of the hydroxyalkyl groups of the anhydroglucose units of the hydroxyalkyl methylcellulose is such that the s6(hydroxyalkyl) is 0.01-0.1, wherein s6 is the molar fraction of the anhydroglucose units of the hydroxyalkyl methylcellulose wherein the hydroxy groups in the 6 position of the anhydroglucose unit are substituted by hydroxyalkyl, and wherein the substitution pattern of the methoxyl groups of the anhydroglucose units of the hydroxyalkyl methylcellulose is such that the s23/s26(methyl) ratio is from 0.36 to 0.60, wherein s23 is the molar fraction of anhydroglucose units wherein only the hydroxy groups in the 2 and 3 positions of the anhydroglucose unit are substituted with methyl, and wherein s26 is the molar fraction of anhydroglucose units wherein only the hydroxy groups in the 2 and 6 positions of the anhydroglucose units are substituted with methyl.

2. The hydroxyalkyl methylcellulose of claim 1, which has a viscosity of from 150 mPa·s to 100,000 mPa·s determined as a 2% by weight aqueous solution at a temperature of 20° C. and a shear rate of 2.51 s⁻¹.

3. The hydroxyalkyl methylcellulose of claim 1, which has a gelation temperature in the range of 55-85° C., the gelation temperature being the temperature at which G/G″=1, G′ being the storage modulus and G″ being the loss modulus of a 2% by weight aqueous solution of the hydroxypropyl methylcellulose.

4. The hydroxyalkyl methylcellulose of claim 1, which has a storage modulus G′ in the range of 10-10000 Pa measured as a 2% by weight aqueous solution at 85° C.

5. The hydroxyalkyl methylcellulose of claim 1, wherein gelation takes place within a 10° C. temperature interval, expressed as an increase of the storage modulus G′ of at least 5 times the storage modulus at the cross-over of G′=G″ within a temperature interval of 10° C.

6. The hydroxyalkyl methylcellulose of claim 1, which has a DS of from 1.0 to 2.0 and an MS of from 0.05 to 0.5, wherein DS is the average number of hydroxyl groups substituted by methoxyl groups per anhydroglucose unit and MS is the average number of moles of hydroxyalkoxyl groups per anhydroglucose unit.

7. The hydroxyalkyl methylcellulose according to claim 6, which has a DS of from 1.2 to 1.8 and an MS of from 0.1 to 0.3, wherein DS is the average number of hydroxyl groups substituted by methoxyl groups per anhydroglucose unit and MS is the average number of moles of hydroxyalkoxyl groups per anhydroglucose unit.

8. The hydroxyalkyl methylcellulose of claim 1, wherein the substitution pattern of the methoxyl groups of the anhydroglucose units of the hydroxyalkyl methylcellulose is such that the s23/s26(methyl) ratio is from 0.40 to 0.48, wherein s23 is the molar fraction of anhydroglucose units wherein only the hydroxy groups in the 2 and 3 positions of the anhydroglucose unit are substituted with methyl, and wherein s26 is the molar fraction of anhydroglucose units wherein only the hydroxy groups in the 2 and 6 positions of the anhydroglucose units are substituted with methyl.

9. The hydroxyalkyl methylcellulose of claim 1, wherein the substitution pattern of the hydroxyalkyl groups of the anhydroglucose units of the hydroxyalkyl methylcellulose is such that the s6(hydroxyalkyl) is 0.04-0.06, wherein s6 is the molar fraction of the anhydroglucose units of the hydroxyalkyl methylcellulose wherein the hydroxy groups in the 6 position of the anhydroglucose unit are substituted by hydroxyalkyl.

10. The hydroxyalkyl methylcellulose of claim 1 which is hydroxypropyl methylcellulose.

11. A composition for the manufacture of an extrusion-molded ceramic body comprising an inorganic material that sets as a result of baking or sintering, the hydroxyalkyl methylcellulose of claim 1 and water.

12. A solid food composition designed to be heat-treated comprising the hydroxyalkyl methylcellulose of claim 1.
